(19) United States
(12) Patent Application Publication
(10) Pub. No.: US 2017/0019755 A1
(43) Pub. Date: Jan. 19, 2017

(54) Self-Adjusting Environmental Behavioral System for GPS/Cellular Locator

(71) Applicant: WhereibleGPS, Roswell, GA (US)

(72) Inventors: Jeff Thacher, Roswell, GA (US); William Holbrook, Birmingham, AL (US); Richard Edmondson, Jacksonville, FL (US)

(21) Appl. No.: 14/801,781

(22) Filed: Jul. 16, 2015

(51) Int. Cl. H04W 4/02

(52) U.S. Cl. CPC H04W 4/02

(57) ABSTRACT

A system and method is provided for wirelessly tracking a tracking device. The subject of the tracking device may be a person, group of people or an article of interest. The tracking device receives location information via GPS and transmits the location information to a remote server via a cellular network or some other communications network. The server may be employed to identify the subject of the tracking device, change operational parameters of the tracking device and may otherwise analyze the information received from the tracking device. Based on the analysis, the server may recommend or may make changes to the operational parameters of the tracking device.

### FIELD OF THE INVENTION

This disclosure relates generally to wireless-tracking solutions and more particularly but not exclusively to systems and methods for wireless tracking using a combination of intelligence, global positioning systems (GPS) and one or more communication technologies such as cellular, WiFi, BlueTooth, etc.

### BACKGROUND OF THE INVENTION

Real time GPS location solutions have been a key part of logistics for many years. However, there are many situations where no full-time power source is available for the tracking of mobile goods and/or people. Lack of location awareness has cost businesses billions of dollars by losing track of people, packages, cargo, containers and other specialty items.

Retail consumers want to know the location and status of their children, elderly parents, vehicles, assets, luggage, purses and other valuable goods. While smartphones can provide location services, they are battery hungry and are too large and expensive to be used solely as a tracking device. Because of these factors, a GPS enabled smartphone is not a practical solution in many situations. Existing “standalone” tracking devices are bulky, expensive and poorly integrated for ease of use.

Conventional tracking solutions also require each tracking device to be manually configured each time the tracking device is attached to a tracked item. This is time sensitive and adds expense to the system.

It would be advantageous to create a relatively inexpensive tracking device that minimizes power requirements and which employs both GPS and cellular technology to provide real-time or substantially real-time location and status. It would further be advantageous to create such a tracking device that employs intelligence.

### BRIEF SUMMARY OF THE INVENTION

Many advantages of the invention will be determined and are attained by the invention, which in a broad sense provides wireless tracking solutions. In at least one embodiment a wireless tracking system is provided. The system includes a tracking device which includes a global positioning system (GPS) module, a cellular circuitry module in electrical communication with the GPS module, a transceiver in electrical communication with the cellular circuitry module, an accelerometer in electrical communication with the cellular circuitry module, a battery in electrical communication with the GPS module, the cellular circuitry module and the accelerometer, and a power management module in electrical communication with the battery. The system also includes a server, located remote from the tracking device. The server includes a transceiver configured to communicate with the tracking device via a cellular network, an intelligence module in electrical communication with the transceiver, and a configuration module in electrical communication with the transceiver and the intelligence module.

In one or more implementations of the invention, a method for wirelessly tracking a location of a tracking device is provided. The method includes the tracking device periodically determining a location of the tracking device via a global positioning system (GPS). The tracking device forwards the location to a remote server via a cellular network, the remote server analyzes the location and determines modifications for the tracking device based at least in part on the analysis.

In one or more implementations of the invention, a method for wirelessly tracking a location of a tracking device is provided. The method includes the tracking device determining a location of the tracking device via a global positioning system (GPS) and determining a change in the location. The tracking device forwards the changed location to a remote server via a cellular network. The remote server forwards the changed location for receipt by a mobile device via a communication network.

In one or more implementations of the invention, a method for wirelessly tracking a location of a tracking device is provided. The method includes the tracking device periodically determining a location of the tracking device via a global positioning system (GPS). The tracking device forwards the location to a remote server via a cellular network, the remote server analyzes the periodically determined location and determines, based at least in part on the analysis, a subject of the tracking device.

The invention will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the invention, reference is made to the following description, taken in conjunction with the accompanying drawings, in which like reference characters refer to like parts throughout, and in which:

FIG. 1 is a block diagram illustrating a wireless tracking device in accordance with one or more embodiments of the invention;

FIG. 2 is a block diagram of a server in accordance with one or more embodiments of the invention;

FIG. 3 is a block diagram of a tracking system in accordance with one or more embodiments of the invention;

FIG. 4 is a flow chart illustrating an operation of tracking system in accordance with one or more embodiments of the invention.

The invention will next be described in connection with certain illustrated embodiments and practices. However, it will be clear to those skilled in the art that various modifications, additions, and subtractions can be made without departing from the spirit or scope of the claims.

### DETAILED DESCRIPTION OF THE INVENTION

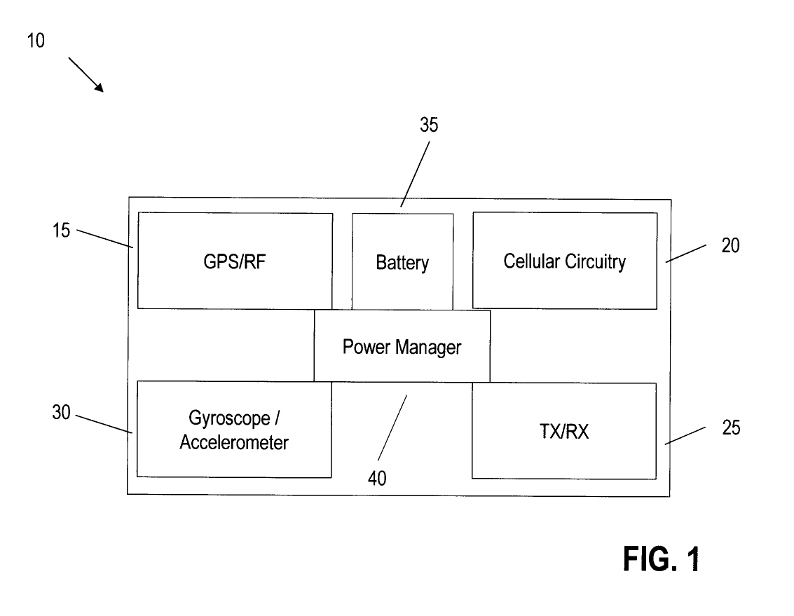

Referring to the drawings in detail wherein like reference numerals identify like elements throughout the various figures, there is illustrated in FIGS. 1-4 a wireless tracking solution. While only a very limited number of system elements (e.g. tracking devices 10, servers 100, user devices 210, networks 205/215, etc.) are illustrated, those skilled in the art will recognize this is only done for illustration purposes and that the invention is not so limited. The wireless locator solution may include multiple servers 100, multiple tracking devices 10, multiple users and/or user devices 210, and can operate over multiple networks or over a single network 205/215. For example, the tracking solution may operate over one or more of the Internet 205, a wireless network 215, a private network, a virtual private network (VPN), a plain old telephone service (POTS) network 220, etc. and it/they may be secure or unsecure and still fall within a scope of one or more embodiments of the invention. It is contemplated by the inventors that the user(s) may employ various mobile devices 210 such as personal digital assistants (PDA), smart phones, tablets, e-readers, smart watches, etc. and/or various computers such as laptops, desktops, thin clients etc. to track and configure the tracking devices 10.

Principles and operations of the invention may be better understood with reference to the drawings and the accompanying description. The following description will be limited to a preferred embodiment(s), but the invention is not intended to be limited to that/those embodiments. Those skilled in the art will recognize that various mechanical and electrical modifications to the described embodiments may occur without departing from a scope of the claims. In the following description, the words locator and tracking will be used interchangeably (e.g. tracking device 10, locator device 10).

In a preferred embodiment as illustrated in FIGS. 1-4 an intelligent location and mapping solution is provided which enables tracking of persons and/or articles. The battery powered locator device 10 utilizes a GPS system to determine the location of the device 10 and one or more wireless networks for data transmission of the location back to a data center. A mapping and reporting application is provided for viewing the device's location and/or movement history on smartphones, tablets and PC's 210.

As illustrated in FIG. 1, the tracking device 10 may be a relatively small, portable, battery powered 35 tracking device 10 that derives its position from GPS 15 but delivers location and other data from the device to a remote server 100 through cellular technology 20. Such data is delivered through the Internet 205 to the end-user and displayed on any PC, smartphone, tablet or other similar device 210. The tracking device 10 employs a GPS module 15 (e.g. a Telit Communications, PLC (LSE-TTCNE) GPS/RF Radio module or similar technology), cellular circuitry 20, one or more transceivers 25 (e.g. an Ethertronics antenna), a gyroscope/accelerometer 30 (e.g. a Freescale accelerometer), a lithium ion battery 35 and a power manager 40. The GPS obtains location information from a GPS system then communicates the location information to the cellular circuitry 20. The cellular circuitry transmits the location information via transceiver 25 to a remote server 100 via a wireless communications network 215. The gyroscope/accelerometer 30 detects force applied to the device 10 and detects if the device 10 has fallen. This information is also provided to the cellular circuitry 20 for transmission to the remote server 100. The battery 35 powers all of the elements of the tracking device 10. The power manager 40 minimizes the amount of power being used when a particular feature or element of the device 10 is not needed or being used. For example, if the device 10 is configured to only report every 20 seconds the power manager may turn off all modules for 20 seconds or some other time less than 20 seconds, or it might turn off select modules such as the cellular circuitry 20 and the transceiver 25. Alternatively or in conjunction the power manager 40 may turn off some or all modules, and lower the power level of some or all modules for a period of time.

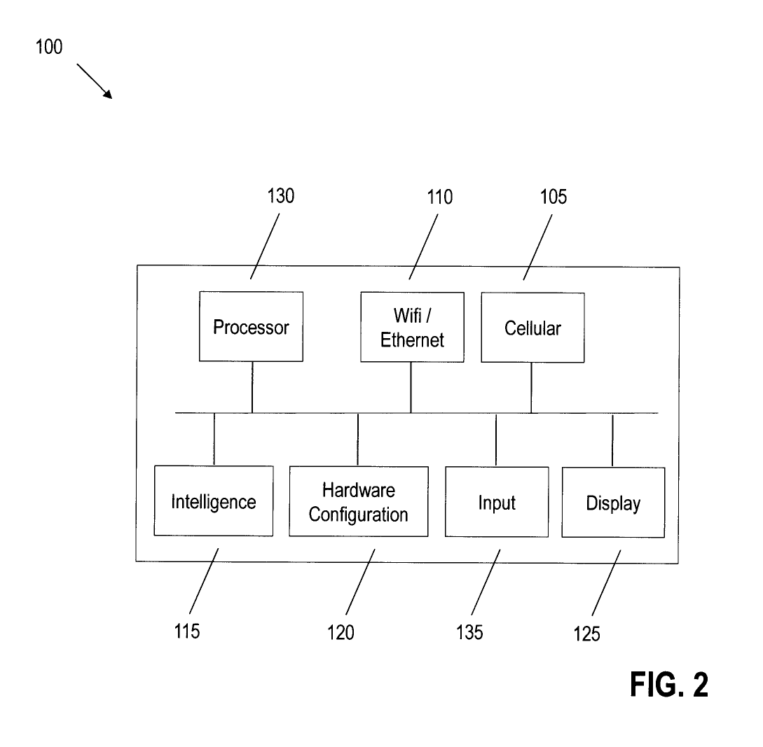

As illustrated in FIG. 2, the server 100 is a processor 130 based device which includes, among other conventional server based elements, a wireless connection 105, an Internet connection 110, intelligence module 115, a hardware configuration module 120 and an input device 135 (e.g. a mouse, keyboard, touchscreen, pen, etc.) and a display 125. The majority of the elements of server 100 are conventional and as such will not be further described herein as those skilled in the art will be familiar with their operation and connection. For example the processor 130, Internet connection 110, display 125, input device 135, cellular circuitry 105, etc. The server 100 also includes an intelligence module 115 and the hardware configuration module 120.

The hardware configuration module 120 is a software based module which dictates how the device 10 operates. The configuration module 120 enables a user to change/dictate the operational parameters of the device 10 such as obtain a live ping, change the report rate of the device, change the report basis of the device (e.g. from time based to movement based reporting, etc.), change the battery performance, create geo-fences and alerts related to the geo-fences, report changes in heading or direction, temperature and g-force shock/fall and take charge of other customizable alerts or reports. The configuration module may also enable a user to auto-detect the device on which the tracking device 10 is attached or with which it is otherwise associated. The hardware configuration module 120 and intelligence module 115 are accessed via an application programming interface (API). The API provides access to device controls, error correction, data analytics, and processing and logical comparisons.

The intelligence module 115, which may be a separate module or the same module as the hardware configuration module 120, enables the device 110 to “learn” about the usual and customary operation of a device and then recommend operational parameters. It is also contemplated that the intelligence module 115 may be provided the capability to automatically configure/update operational parameters of the device 10. The device 10 may “learn” over time how, where and why it is being moved around and behaving a certain way. Iterative defined states of historical patterned behavior which are specific to the device 10 are analyzed and then applied to a decision tree to make recommendations for or modifications to the operating parameters of the device 10. In other words, data received from the device 10 and/or manually entered into the intelligence module 115 is stored on server 100 and then analyzed on a periodic basis, in real-time or substantially in real-time by the intelligence module 115. The data is analyzed against various if-then and/or if-then-else statements and/or it may be analyzed against one or more thresholds. By way of a non-limiting example, if the data received from the device 10 indicates that the device 10 continually (as defined by the design choices of the system) only travels between 2 locations, then the intelligence module 115 may define or may recommend to the user to define a geo-fence for the area between those two locations and may suggest or set up an alert for when the device 10 leaves that geo-fenced area. The above example could also be limited by time or some other parameter. For example, if the intelligence module 115 is informed that the tracking device 10 is associated with a student and determines that from 8:30 am until 9:00 am every Monday through Friday, inclusive, the student travels from home to school and each of those same days leaves the school and returns home between 3:00 pm and 3:30 pm the intelligence module 115 may define or may recommend to the user to define a geo-fence for the area between the home and the school for Monday's through Fridays, inclusive, which is only active from 8:30 am-9:00 am and 3:00 pm-3:30 pm and may also suggest or set up an alert for when the student's device 10 leaves the geo-fenced area, enters the geo-fenced area, fails to enter the geo-fenced area during one of those time periods or if the device 10 is not present in the geo-fenced area during those time periods. By way of another non-limiting example, the intelligence module 115 could determine that from 11:00 pm to 7:00 am every day the tracking device 10 remains stationary (e.g. the student is asleep). The intelligence module 115 may configure or may recommend to the user to configure the power module 40 on the device 10 to shut down for all or part of that time period, and/or to increase the time period between the tracking device's 10 reporting and/or to change the reporting requirement to a movement based report. This learned behavior can then be used to tailor and/or optimize the operational parameters of the device.

The intelligence module 115 may also be employed to automatically identify the subject of the tracking device 10. To that end, the intelligence module 15 is provided access to one or more tracking profiles. A tracking profile includes one or more expected/usual and customary behaviors that a particular subject of the tracking device 10 exhibits. If the tracking device 10 matches all of the behaviors of a particular profile or a predefined number or percentage of behaviors then the intelligence module 115 determines that the tracking device is attached/associated with a subject matching that particular profile. It is possible that a subject will match multiple profiles. In that event, the system may be designed to select the best fit or some other profile based upon a design choice of the system. Once the subject is determined the intelligence module 115 communicates that information to the hardware configuration module which then downloads a default configuration for that particular subject. At that point, the tracking device 10 may be configured to continue reporting as usual, or may be configured to only report anomalous activity based on the profile.

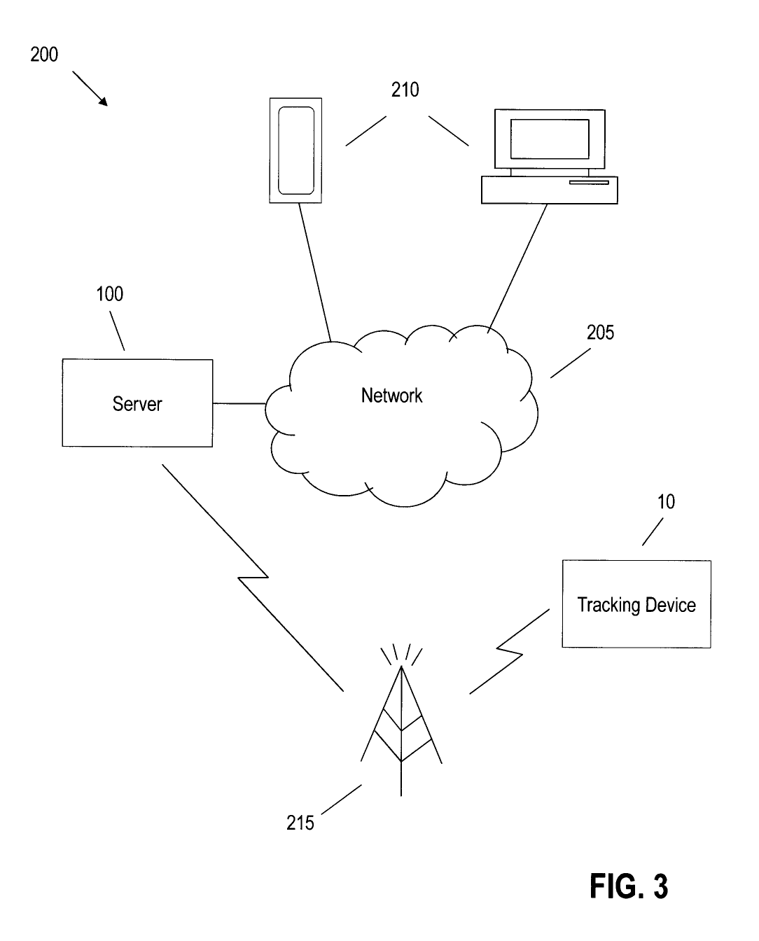

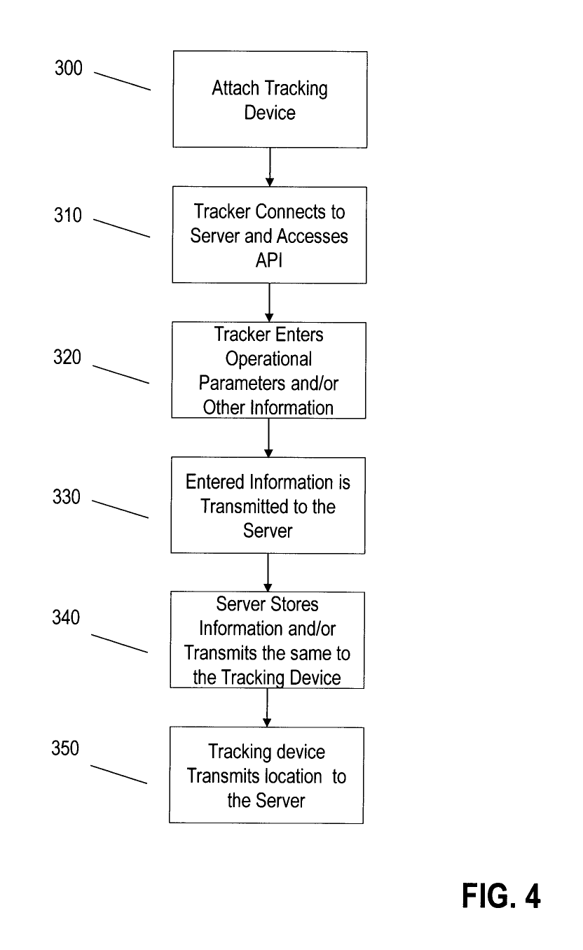

In operation FIG. 4, at 300 the tracking device 10, which has a unique identifier, is attached to a person or an article to be tracked. The tracking device 10 is programmed to operate with certain default parameters such as report location every 10 minutes, or report location every 100 feet. Those skilled in the art will recognize that the default parameters are a design choice and thus other default parameters may be selected without departing from a scope of the claims. Additionally, the tracking device 10 could be provided with no default operating parameters and still fall within a scope of the claims. As illustrated in FIG. 3, using a computer, smartphone or similar device 210 (hereinafter referred to as the smartphone 210), at 310 the person who wants to track the tracking device 10 (hereinafter the tracker) may connect to the server 100 via the Internet (or some other communications network depending upon the design choice of the system). The API is presented to the tracker via the smartphone 210 such that the tracker can select operational parameters to set for the tracking device 10. In addition to being able to set the operational parameters, the API may provide the tracker with the ability to view the location of the tracking device in map view or some other view, it may provide the tracker with the ability to view historical data about the tracking device 10 (e.g. locations within last 12 hours, how long it remained at a location, and other analytics about the tracking device 10). The tracker may enter information about the tracking device (e.g. identifying information about the person or article being tracked, limits on the allowed locations/movements for the tracked device etc.). This information may be entered using radio boxes, drop down menus, or using other conventional data input options. At 330, information entered into the smartphone is then transmitted to the server 100 via the Internet, and at 340 the server 100 stores the information and/or transmits the operational parameters via cellular carrier 215 to the tracking device 10. Once operational, at 350 the tracking device periodically transmits its location to the server via cellular network 215. That period may be customizable by the tracker and may be based on time and or movement of the device. For example, the device 10 may be configured obtain and report its location every minute or every 10 minutes or some other time period. It may also or alternatively be configured to report its location every time the tracking device moves more than 100 feet, or some other distance. In the event that the tracking device 10 detects a fall or some other sudden force acting on the device 10 it could be programmed to send an alert that it has fallen or otherwise been in some type of accident.

In addition to or alternatively, the above system may automatically determine the subject of the tracking device 10. The tracking device 10 is attached to a subject and sometime thereafter begins to report for a certain period of time, or for a certain number of reports. After a sufficient amount of data is received (e.g. after a few hours or days or x number of reports) by the server 100, and/or as the data is received, the intelligence module 115 compares the data to one or more profiles and/or to various if-then and/or if-then-else statements and makes a determination as to an identity of the subject matter of the tracking device 10 (e.g. a person, a car, a shipping container, a golf cart, a shopping cart, etc.) and the hardware configuration module 120 sets the operational parameters for the tracking device 10. In this manner, if the tracking device 10 is removed from one subject and attached to/associated with a different subject, the system can determine the change without the need for human intervention.

Having thus described preferred embodiments of the invention, advantages can be appreciated. Variations from the described embodiments exist without departing from the scope of the claims. Thus it is seen that wireless tracking solutions are provided. Although particular embodiments have been disclosed herein in detail, this has been done for purposes of illustration only, and is not intended to be limiting with respect to the scope of the claims, which follow. In particular, it is contemplated by the inventors that various substitutions, alterations, and modifications may be made without departing from the spirit and scope of the invention as defined by the claims. For example, the tracking device 100 may also employ a radio frequency transceiver for instances where cellular or GPS is unavailable, but local RF readers and repeaters are available. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described systems is envisaged as an aspect of the invention. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A wireless tracking system comprising:
a tracking device including a global positioning system (GPS) module; a cellular circuitry module in electrical communication with said GPS module; a transceiver in electrical connection with said cellular circuitry module; an accelerometer in electrical communication with said cellular circuitry module; a battery in electrical communication with said GPS module, said cellular circuitry module and said accelerometer; and, a power management module in electrical communication with said battery; and, a server, located remote from said tracking device; said server including a transceiver configured to communicate with said tracking device via a cellular network; an intelligence module in electrical communication with said transceiver; and a configuration module in electrical communication with said transceiver and said intelligence module; wherein said tracking device is configured to operate in accordance with at least one operating parameter and wherein said configuration module is configured to selectively communicate with said tracking device to modify said at least one operating parameter and to communicate said at least one operating parameter to said tracking device.

2. (canceled)

3. The wireless tracking system according to claim 1 wherein said at least one operating parameter includes an operating parameter selected from the group of operating parameters consisting of: a location reporting rate, a ping, a power management, and a location reporting basis.

4. The wireless tracking system according to claim 3 wherein said at least one operating parameter includes a plurality of operating parameters.

5. The wireless tracking system according to claim 4 wherein said plurality of operating parameter includes at least two operating parameters selected from the group of operating parameters consisting of: a location reporting rate, a ping, a power management, a location reporting basis and a generate an alert.

6. The wireless tracking system according to claim 1 wherein wherein said intelligence module is configured to receive data from said tracking device, analyze said data and identify at least one modification to make to said at least one operating parameter.

7. The wireless tracking system according to claim 6 wherein said configuration module is configured to receive said identified modification and communicate said modification to said tracking device.

8. The wireless tracking system according to claim 1 wherein said GPS module obtains a location information for said tracking device and communicates said location information to said server; and further comprising a mobile device in selective communication with said server via a communication network; wherein said mobile device is configured to receive said location information from said server.

9. A method of wirelessly tracking a location of a tracking device, said method comprising:
said tracking device periodically determining a location of said tracking device via a global positioning system (GPS);
said tracking device forwarding said location to a remote server via a cellular network;
said remote server analyzing said location and determining modifications for said tracking device based at least in part on said analysis; and,
said server transmitting said modifications to said tracking device.

10. The method according to claim 9 further comprising said server receiving operational parameter settings for said tracking device and forwarding said operational parameter settings to said tracking device for implementation by said tracking device.

11. The method according to claim 9 further comprising said tracking device determining a change in location of said tracking device and said tracking device forwarding said change in location to said remote server via a cellular network.

12. The method according to claim 9 further comprising said server receiving a plurality of locations from said tracking device wherein said server analyzes said plurality of locations and generates a geo-fence based upon said analysis to geographically surround an area.

13. The method according to claim 12 further comprising said server generating an alert when said tracking device deviates from said geo-fenced area.

14. The method according to claim 9 further comprising said tracking device determining falling information via a gyroscope that said tracking device has fallen and forwarding said falling information to said remote server.

15. The method according to claim 14 further comprising said server, in response to receipt of said falling information, generating an alert and forwarding said alert for receipt by a user device.

16. A method of wirelessly tracking a location of a tracking device, said method comprising:
said tracking device determining a location of said tracking device via a global positioning system (GPS), said tracking device determining a change in said location;
said tracking device forwarding said changed location to a remote server via a cellular network;
said remote server forwarding said changed location for receipt by a mobile device via a communication network only if said changed location is greater than a predetermined distance from said location of said tracking device.

17. The method according to claim 16 further comprising said server receiving operational parameter settings for said tracking device and forwarding said operational parameter settings to said tracking device for implementation by said tracking device.

18. The method according to claim 16 further comprising said server receiving a plurality of locations from said tracking device wherein said server analyzes said plurality of locations and generates a geo-fence to geographically surround an area.

19. The method according to claim 18 further comprising said server generating an alert when said tracking device deviates from said geo-fenced area.

20. The method according to claim 16 further comprising said server analyzing a history of said changes in said location; changing an operational parameter of said tracking device based at least in part on said analysis; and transmitting said changed parameter to said tracking device for implementation by said tracking device.

21. A method of wirelessly tracking a location of a tracking device, said method comprising:
said tracking device periodically determining a location of said tracking device via a global positioning system (GPS);
said tracking device forwarding said periodically determined location to a remote server via a cellular network;
said remote server analyzing said periodically determined location and determining, based at least in part on said analysis, a subject of said tracking device.

22. The method according to claim 21 wherein said analyzing includes comparing said periodically determined locations to a stored subject profile.
